(19) United States
(12) Patent Application Publication
(10) Pub. No.: US 2003/0151485 A1
(43) Pub. Date: Aug. 14, 2003

(54) Surface mounted inductance element

(76) Inventor: Charles Lewis, San Diego, CA (US)

Correspondence Address: J.W. Gipple, GIPPLE & HALE, P.O. Box 40513, Washington, DC, 20016, US

(21) Appl. No.: 10/068,529

(22) Filed: Feb. 8, 2002

(51) Int. Cl. H01F 5/00

(52) U.S. Cl. 336/200

(57) ABSTRACT

A surface mountable inductor is provided which is a rectangular cross section coil mounted to a dielectric block. The inductor avoids mechanical vibration and provides a flat top surface to facilitate use, for example, in circuit boards. Attachment of the device is facilitated by bi-sected connecting terminals.

### CROSS REFERENCE TO RELATED APPLICATION

This application is a continuation-in-part of co-pending application Ser. No. 09/709,615.

### FIELD OF THE INVENTION

The present invention refers to a high Q factor chip inductor for use in high frequency circuits, that is frequencies higher than 500 Megahertz.

It is surface mountable, having reduced susceptibility to vibration and suitable for use, for example, in circuit boards.

### BACKGROUND OF THE INVENTION

In modern electrical designs, there is a continued effort to reduce size and improve the performance of circuit components. One such component is the surface mounted inductor which can be used as a resonator, as an RF choke, or as a component in a hybrid filter, as well as various other applications. Modern manufacturing techniques require that the majority, if not all of the electronic components found in an assembly be capable of being surface mounted in order to decrease manufacturing time. Surface mountable inductors can be formed using one of several known technologies including molded electronic component technology, wire wound chip inductor technology and printed circuit board technology.

Existing air wound inductors employ a self supported coil of enameled wire with straight non-enameled ends for soldering on a printed circuit board. The Q value of such a coil is dependent on the diameter of the wire so that a larger diameter results in a higher Q value. These airwound inductors of the prior art suffer from two disadvantages. They are highly susceptible to mechanical vibrations since they are essentially springs. The inductance of the coil also will vary in time according to mechanical vibrations, thereby causing a negative impact on the performance of the electronic circuit to which the coil is connected. Additionally, these air wound inductors cannot be handled by the equipment used in the assembly of surface mounted printed surface boards since such circuit boards require that the component have a flat top surface. Accordingly, it would be desirable to provide an improved surface mountable inductor that avoids the problem of mechanical vibration and provides a flat surface to facilitate mounting on circuit board assemblies.

The latest advances in wireless technology have created the demand for a surface mounted high Q factor inductor for use in high frequency circuits, including oscillators and filters. The existing solution or prior art for a printed inductor is a coil consisting of two spiral windings; one spiral winding on the top side of the dielectric substrate and one spiral winding on the bottom side of said substrate. The axis of such coil is perpendicular to both top and bottom side of the substrate. SUMMARY OF THE INVENTION

The present invention provides a surface mountable inductor which substantially avoids the aforementioned disadvantages of the prior art.

In accordance with the invention, a surface mountable inductor is provided which essentially comprises a first plurality of sequentially disposed conductive surface circuits formed on one of two parallel spaced apart surfaces of a dielectric substrate and a second plurality of similar sequentially disposed conductive surface circuits formed on the other of the two surfaces of the dielectric substrate. Each of the respective circuits is separated from one another and the terminal end of each conductive circuit on one surface of the substrate; and connected by means of a via hole in a terminal end to an opposing terminal end of a circuit on the other surface of the substrate. Thus, a flat inductor is provided having a rectangularly spiral configuration with a plane intersecting a plane surface of the dielectric substrate. Conveniently, the initial terminal and the last terminal in the inductor structure are bisected to provide connecting points for the entire device. Further, the rectangular cross section foil formed by the conductive strips and via holes is not subject to vibrations since it is attached to the rigid dialectic substrates.

### BRIEF DESCRIPTION OF THE DRAWINGS

FIG. 1 is a perspective view of a typical self supported, coiled air-wound inductor of the prior art;

FIG. 2 is a perspective view of the surface mountable inductor of the present invention;

FIG. 3 is a perspective view of the present invention illustrating bisected connector elements.

FIG. 4 is a top plan view of the inductor chip.

FIG. 5 is a side view of the inductor chip with phantom lines illustrating internal elements.

FIG. 6 is a bottom plan view of the inductor chip.

FIG. 7 is a side view of the inductor chip mounted on a circuit board.

### DETAILED DESCRIPTION OF PREFERRED EMBODIMENTS OF THE INVENTION

In accordance with preferred embodiments of the present invention, as illustrated herein, a surface mountable inductance element having high Q value and reduced susceptibility is provided.

Reference will now be made in detail to the present preferred embodiment of the invention, an example of which is illustrated in the accompanying drawings.

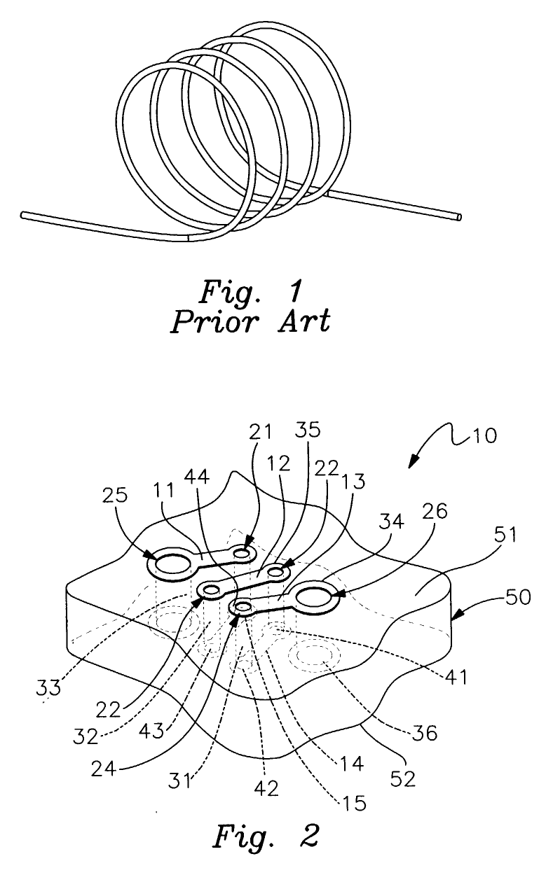

Referring to FIG. 2 of the drawings, a surface mounted inductor of the invention is shown generally at 10 and comprises a first plurality of sequentially disposed conductor circuits which are conductive strips 11, 12, and 13 mounted on the upper surface 51 of dielectric block 36.

A second plurality of sequentially disposed conductor circuits are conductive strips 14 and 15, partially shown in phantom, on the bottom side 52 of dielectric block 36. Each of the conductor circuits comprises an elongated strip having a terminal at each of its ends. Circuit 11 has terminals 21 and 25; Circuit 12 has terminals 22 and 23; Circuit 13 has terminals 24 and 26. On the bottom surface 52, Circuit 14 has terminals 41 and 42; Circuit 15 has terminals 43 and 44. The respective terminals of the first plurality of conductor circuits are respectively connected through via holes in the dielectric block 36 to opposing terminals in the second plurality of conductor circuits. Thus, for example, via 31 connects terminals 24 and 42, via 32 connects terminals 22 and 43; via 34 connects terminals 23 and 41; via 35 connects terminals 21 and 44. Thus a complete electrical connection is achieved between the respective circuits on both surfaces of the dielectric block. Clearly, the number of circuits can be varied as desired.

The terminals at the ends of each elongated circuit strip comprise a conductive ring around the respective, engaging via hole.

The diameter of the via holes and the width of the conductive strips can be similar to the width of the conductor used in typical air-wound inductors.

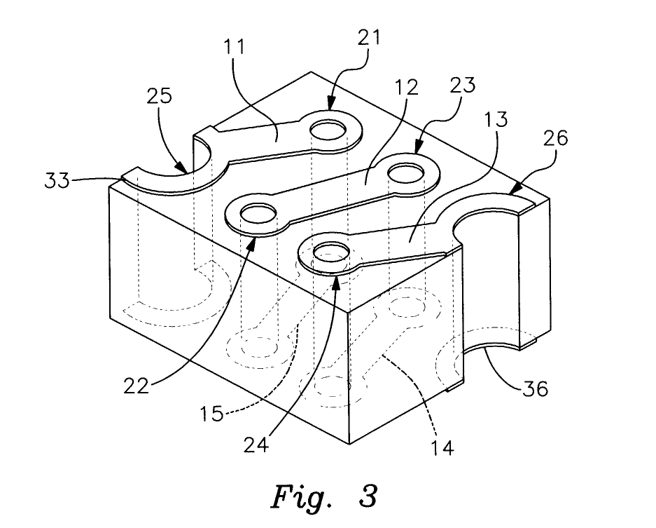

As particularly shown in FIG. 3 of the drawings, the initial terminal 25 and last terminal in the circuit 26, can be somewhat larger than the other terminals and are preferably bisected to provide connectors at each surface. Bisecting of the terminals is conveniently accomplished by cutting through the entire dielectric block as shown.

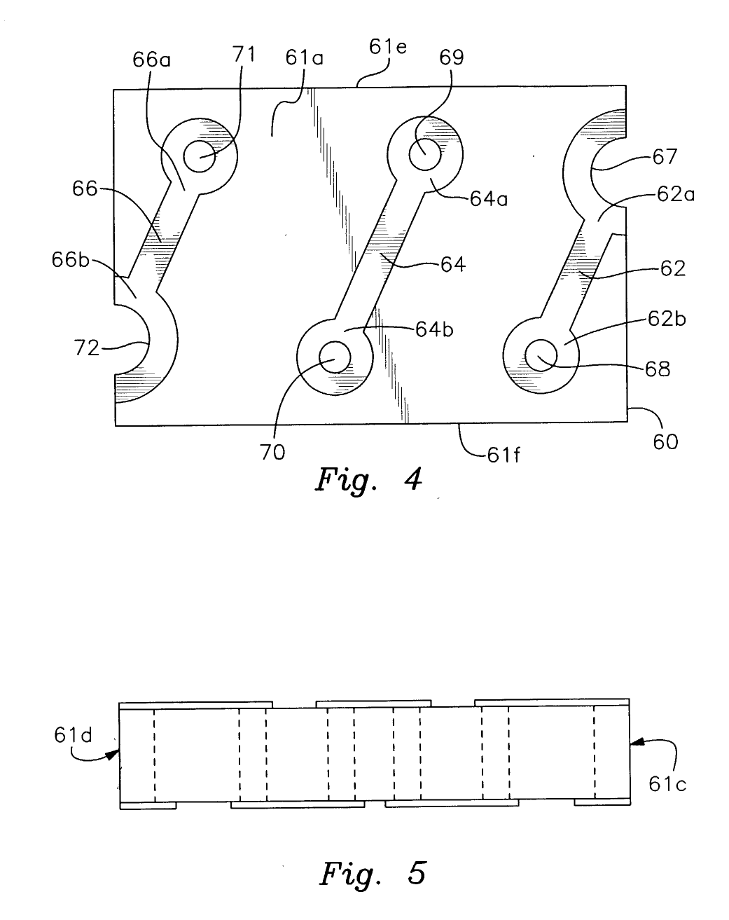

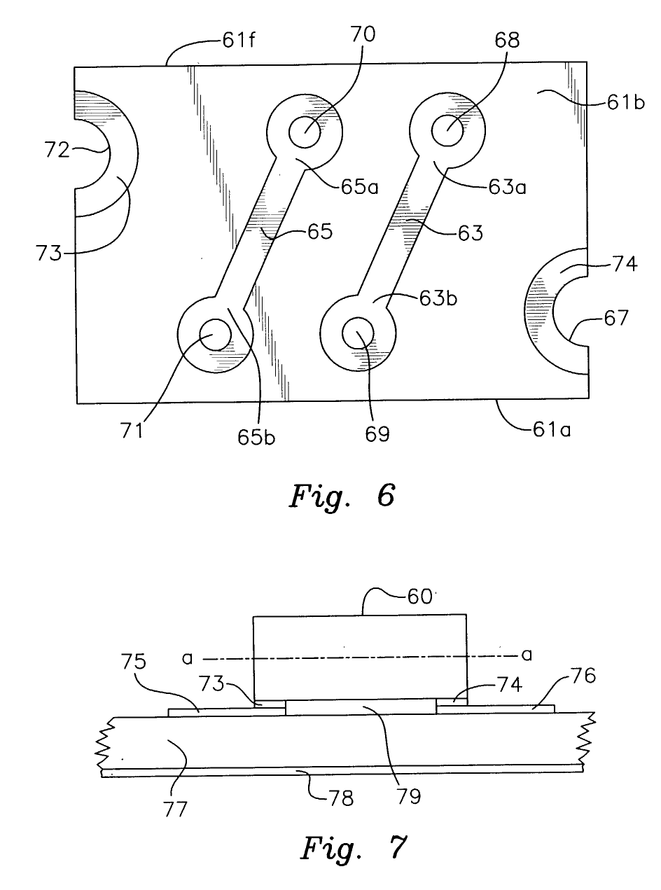

The inductor of the present invention, as shown in FIGS. 4, 5 and 6 is a high Q factor chip inductor 60, which comprises a coil formed by the conductive strips 62, 63, 64, 65 and 66, which are interconnected by the conductive via holes (or tubes) 68, 69, 70 and 71. The chip inductor 60, also includes an initial (or entry) terminal 73 and a last (or exit) terminal 74.

The terminals 73 and 74 are formed at the bottom ends of conductive half holes (or bisected tubes) 67 and72. The open exposed conductive surface of the half holes (or bisected tubes) 67 and 72, facilitate a better solder joint to the conductive surface upon which the inductor chip is mounted.

From FIG. 7, it will be understood that the high Q factor chip inductor 60 is intended to be mounted on a surface such as a printed circuit board substrate 77, with a conductive ground plane 78. On the upper surface of the circuit board 77, there are entry solder pad 75 and exit solder pad 76. The initial (entry) terminal 73 is solder connected to entry solder pad 75. The last (exit) terminal 74 is solder connected to the exit solder pad 76. There is a space 79 between the inductor chip 60 and the circuit board 77, which allows air circulation to prevent overheating.

The line a-a of FIG. 7 indicates the axis of the coil formed by the interconnected conductive elements of chip inductor 60. This axis is perpendicular to sides 61c and 61d; parallel to top side 61a and to bottom side 61b.

It is known from electrical physical theory that the magnetic field of a coil inductor is most intense along the axis of said coil. An A.C. current flowing through an inductor generates a time-varying magnetic field. This magnetic field will induce eddie currents on any conductive object in its vicinity. Thus, high frequency A.C. currents flowing through an inductor mounted on a printed circuit board with a conductive bottom plane will induce eddie currents on said conductive plane. The intensity of these eddie currents is directly proportional to the intensity of the magnetic field on the surface of the conductive ground plane. These eddie currents generate heat, which is a form of energy. The law of conservation of energy dictates that this heat comes from the electric energy applied to the coil. Therefore, a way to minimize the energy losses in the coil and thus maximize the coil's Q factor is to minimize the eddie currents on the conductive ground plane. Since the coil's magnetic field is most intense along the coil's axis, this is achieved by moving the coil's axis, this is achieved by moving the coil's axis, where the magnetic field is most intense, away from the conductive ground plane. The coil axis in the invention is perpendicular to side 61c and side 61d. When the inductor of this invention is mounted on a printed circuit board having a conductive ground plane, the coil axis does not intersect said conductive ground plane. If a chip inductor is built according to the prior art and mounted on a printed circuit board having a conductive ground plane, the inductor's coil axis would be perpendicular to the top and bottom side of said printed circuit board and would therefore intersect the conductive ground plane. A chip inductor built according to the present invention and mounted on a printed circuit board with a conductive ground plane on the bottom side exhibits a higher Q factor than a chip inductor built according to the prior art and mounted on a printed circuit board.

The dielectric substrate can be formed from a variety of materials including ceramics, polytetrafluoro ethylene, alumina, and G-10 or FR-4, which are fiber cloth impregnated with different types of expoxy resin and pressed at high temperature into flat sheet.

Procedures and materials used in accordance with the invention for the conductive circuits, via hole fabrication and dielectric block will be understood to be conventional.

The present invention, however, provides an improvement over conventional air-wound inductors because it is not subject to vibration as in other circuit board assemblies.

It will further be apparent to those skilled in the art that various modifications and variations can be made in the inductor of the present invention without departing from the spirit or scope of the invention. Thus it is intended that the present patent application cover modifications and variations of this invention that come within the scope of the appended claims and their equivalents.

What is claimed is:

1. A surface mountable inductor comprising:
a first plurality of sequentially disposed conductive circuits formed on one of two, parallel spaced apart surfaces of a dielectric substrate;
a second plurality of sequentially disposed conductive circuits formed on the other of said two surfaces; each of the circuits of said first plurality and the circuits of said second plurality being separated from one another by said dielectric material;
each terminal of a conductive strip of said first plurality of conductive circuits being respectively connected through a via hole in said dielectric material to an opposing terminal of a conductive strip of said second plurality of conductive circuits; such that said conductive circuits and via holes are connected to form a rectangularly spiral conductor within a plane intersecting a plane surface the dielectric substrate;

2. The surface mountable inductor of claim 1, wherein said dielectric material is cut through to bisect said conductor ring and via hole in the initial and last terminal.

3. The surface mountable inductor of claim 1 wherein the conductor rings of said initial and last terminals are of greater diameter than the remainder of the conductor rings.

4. A surface mountable inductor comprising:
a first plurality of sequentially disposed conductive circuits formed on one of two parallel spaced apart surfaces of dielectric substrate;
said substrate having a top surface, a bottom surface, and three or more side surfaces.
a second plurality of sequentially disposed conductive circuits formed on the other of said two parallel surfaces; each of the circuits of said first plurality and the circuits of said second plurality being separated from one another by said dielectric material;
each terminal of a conductive strip of said first plurality of conductive circuits being respectively connected through a via hole in said dielectric material to an opposing terminal of a conductive strip of said second plurality of conductive circuits; such that said conductive circuits and via holes are connected to form a rectangularly spiral conductor having an axis through the substrate, between and parallel to the top surface and bottom surface of said substrate

5. The surface mountable inductor of claim 1, wherein said dielectric material is cut through to bisect said conductor ring and via hole in the entry and exit terminal.

6. The surface mountable inductor of claim 1 wherein the conductor rings of said entry and exit terminals are of greater diameter than the remainder of the conductor rings.
